(19) United States
(12) Patent Application Publication
(10) Pub. No.: US 2023/0381621 A1
(43) Pub. Date: Nov. 30, 2023

(54) EXOSKELETON ROBOTIC SYSTEM FOR GOLF-SWING TRAINING AND MEDICAL REHABILITATION

(71) Applicant: David Willard Peterson, Edmonds, WA (US)

(72) Inventor: David Willard Peterson, Edmonds, WA (US)

(21) Appl. No.: 18/084,377

(22) Filed: Dec. 19, 2022

Related U.S. Application Data
(63) Continuation of application No. 17/486,529, filed on Sep. 27, 2021, now abandoned.
Application No. 17/486,529 is a continuation of application No. 16/529,480, filed on Aug. 1, 2019, now abandoned.
(60) Provisional application No. 62/713,390, filed on Aug. 1, 2018.

(51) Int. Cl. A63B 69/36; A61H 1/02; A63B 69/00

(52) U.S. Cl. CPC A63B 69/3608; A61H 1/02; A61H 1/0274; A63B 69/0057; A63B 2102/32

(57) ABSTRACT

A robotic training device, system and method duplicates and guides a golfer through a perfect golf swing in several modes. The exoskeleton-like robotis device, and system utilizes a training method that employs a combination of either pneumatic, electrics or Bowden cables with small motors and actuators, which embraces the golfer so he/she can experience the “feel” and body movements that make a perfect golf swing and learn to perform the motion without the training device. Similarly, the robot training device, system may assist patients in rehabilitation from injuries, stroke, chronic illness or other conditions involving muscular atrophy.

### PRIORITY CLAIM

This application is a continuation of U.S. patent application Ser. No. 17/486,529 filed Sep. 27, 2021, which claims priority from and the benefit of U.S. Provisional Application No. 62/713,390 filed Aug. 1, 2018; which application is incorporated by reference in its entirety as if fully set forth herein.

### FIELD OF THE DISCLOSURE

The present disclosure relates generally a robotic exoskeleton and more specifically to a robotic training device and system that duplicates and guides a user to improve his/her golf swing and assists patients in rehabilitation.

### BACKGROUND OF THE INVENTION

There is an insatiable demand for products and training aids to help learn a proper golf swing. All previous instruction devices, systems and methods involve an instructor guiding a student through the proper motion. Technical systems such as swing monitors and ball-flight monitors do not guide the student but simply measure results. It is difficult and for many, impossible to duplicate the instructions of a teacher and adopt their directions into one's own swing. This is how bad habits are formed which are often difficult to reverse. It is equally difficult to verbalize instructions in to a practice regimen. Accordingly there is a need for such a robotic system, device and method for golfers. Similarly, there is a need for robotic systems, devices and methods to assist patients in rehabilitation from injuries, stroke, chronic illness or other conditions involving muscular atrophy.

### SUMMARY OF THE INVENTION

A robotic device, system and method comprising at least one from the group of robotic exoskeletons for improving a golf swing, and for assisting patients in rehabilitation.

### BRIEF DESCRIPTION OF THE DRAWINGS

Preferred and alternative examples of the present invention are described in detail below with reference to the following drawings:

FIGS. 1A-1D illustrates multiple view points of the robotic exoskeleton at start of swing;

FIGS. 2A-2D illustrates multiple view points of the robotic exoskeleton at peak of swing;

FIGS. 3A-3D illustrates multiple view points of the robotic exoskeleton at follow through point of swing;

FIGS. 4A-4D illustrates multiple view points of the robotic exoskeleton at end of swing; and,

FIG. 5 illustrates an example of the exoskeleton on a subject.

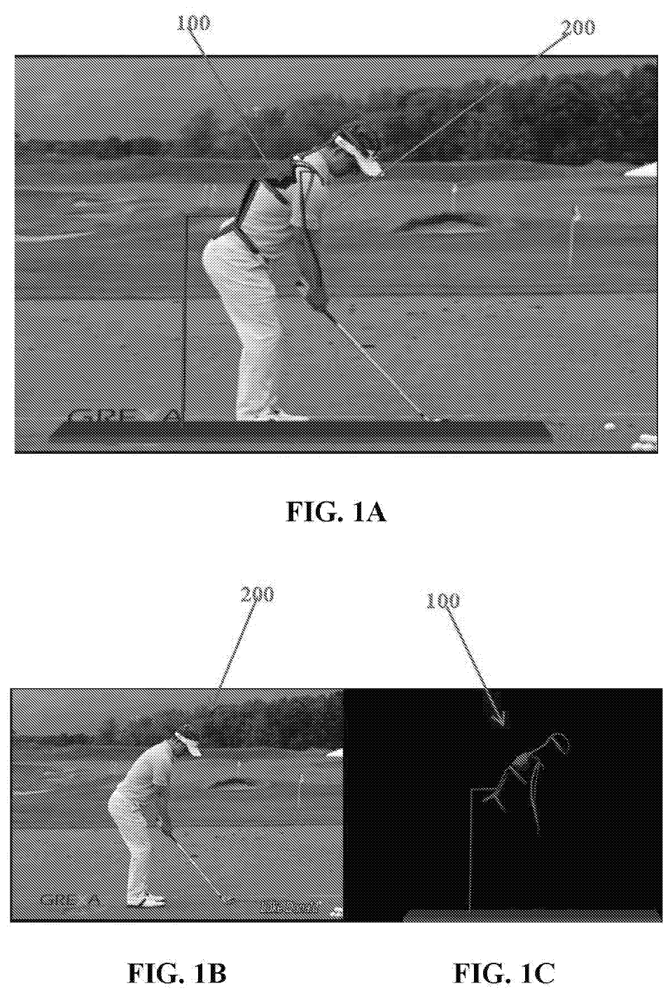

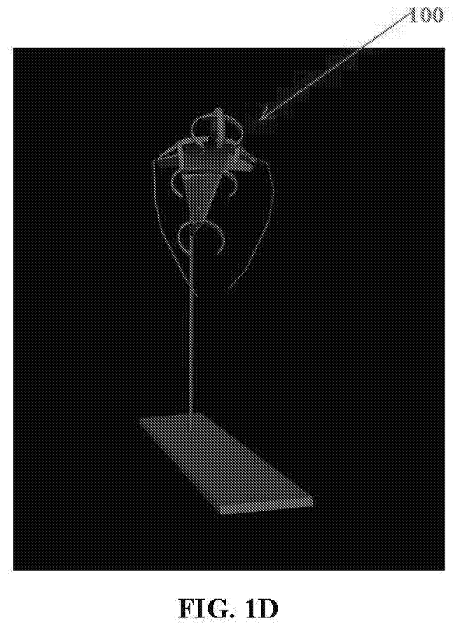

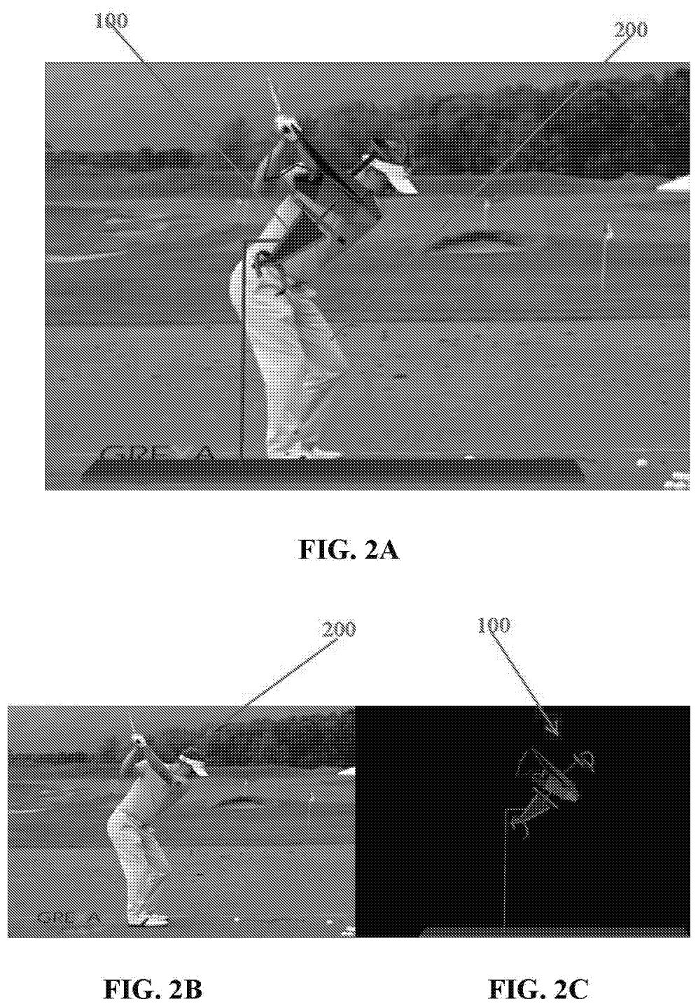

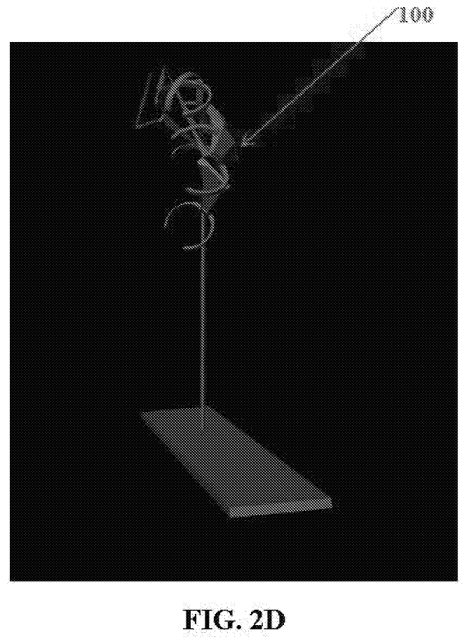

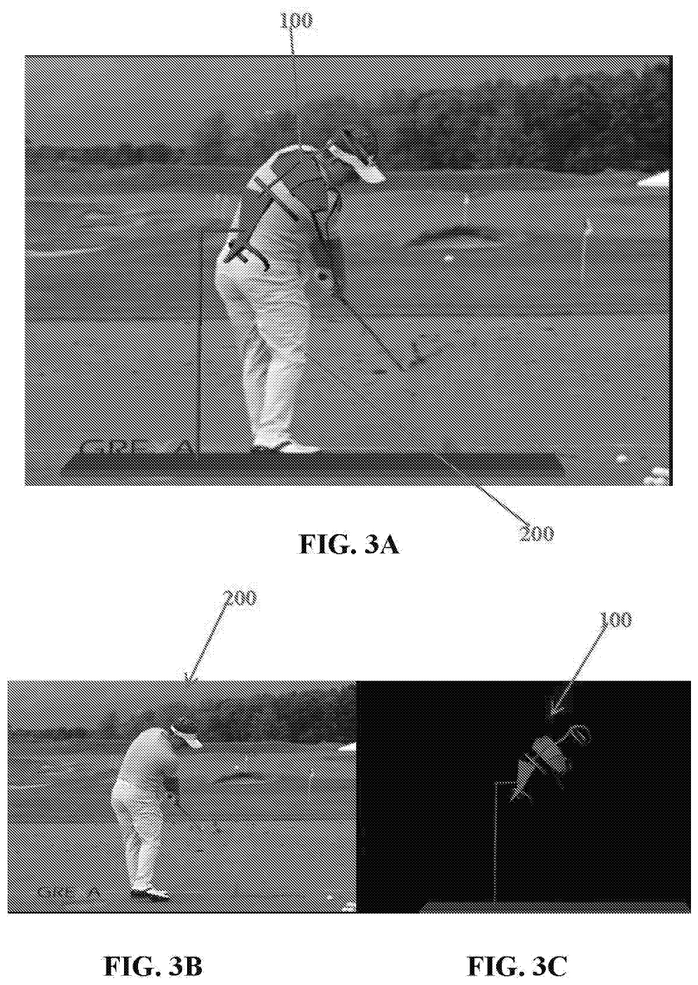

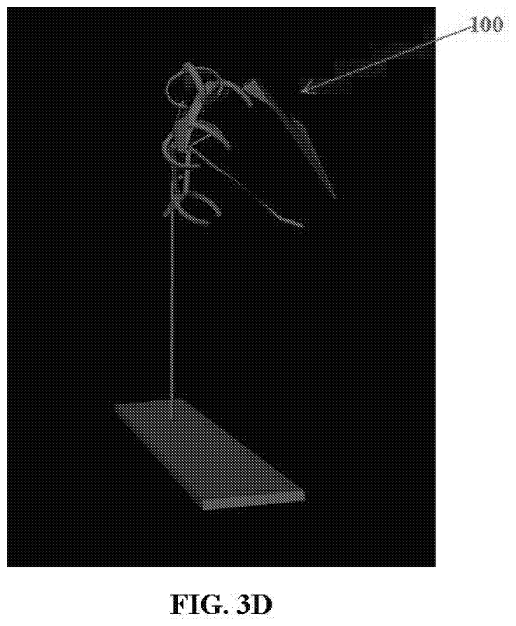

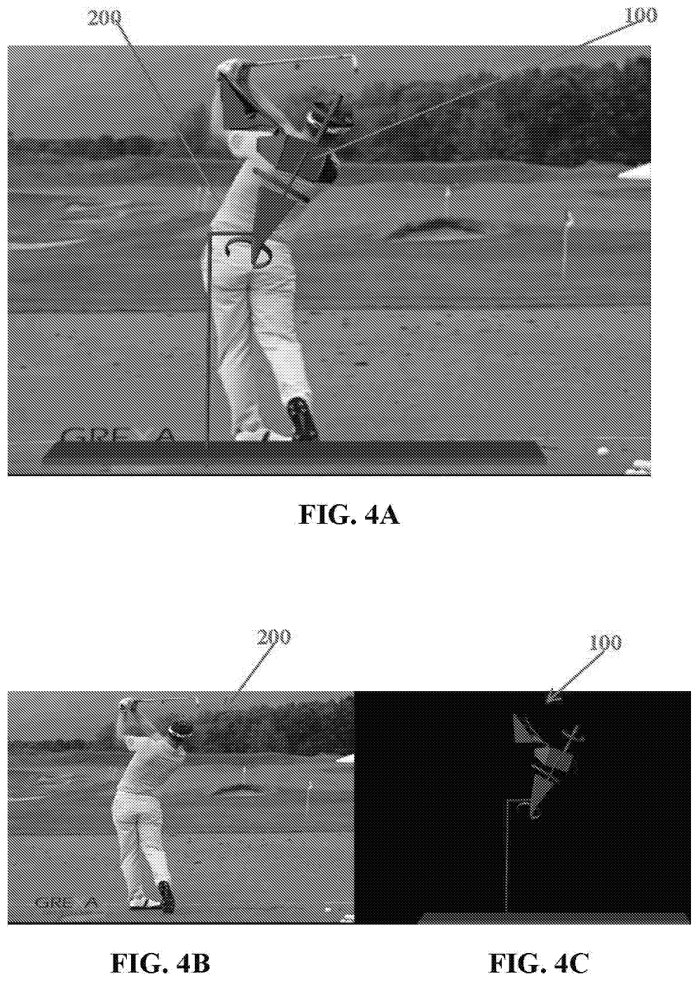

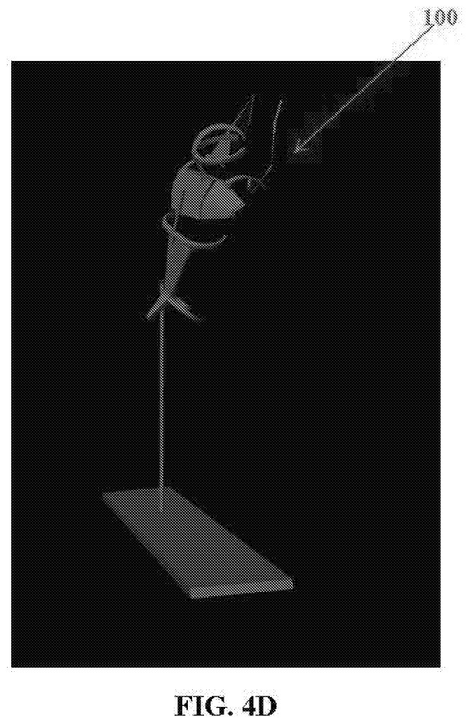

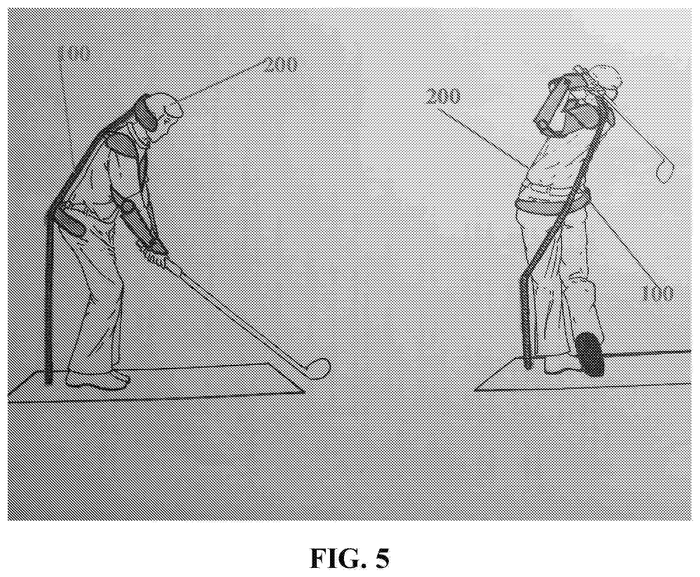

### DETAILED DESCRIPTION OF THE PREFERRED EMBODIMENT

The invention may instruct and guide a student through a complex interconnected series of motions that produce an ideal golf swing to improve skill and enhance enjoyment of the game of golf. It may also assist patients in rehabilitation from injuries, stroke, chronic illness or other conditions involving muscular atrophy.

A robotic training device 100 that duplicates and guides a golfer 200 through a perfect golf swing in several modes. It is an exoskeleton-like robot that employs a combination of either pneumatic, electrics or Bowden cables with small motors and actuators, which embraces the golfer so he/she can experience the “feel” and body movements that make a perfect golf swing and learn to perform the motion without the training device. The swing motion of a professional golfer or teaching pro can be captured by the software component of the exoskeleton robot (the “record” mode), which can then be used as the model for training students (the “play” mode). The robot can also operate independently from the user so the user can observe the motion which he will try to emulate in the training mode. The device 100 includes a tubular structure constructed of light weight metal alloy or carbon fiber, and carbon fiber arm “sleeves” and gloves. See figures. Small motors and actuators controlled by software effectuate the robot's motion

The invention could be adopted by equipment manufacturers, golf training service providers and rehabilitation machine equipment manufacturers such as Nike, Titelist, Golftec, TrackMan Golf, Medtronic, Stryker etc.

The invention may instruct and guide a student through a complex interconnected series of motions that produce an ideal golf swing to improve skill and enhance enjoyment of the game of golf. It may also assist patients in rehabilitation from injuries, stroke, chronic illness or other conditions involving muscular atrophy.

There is an insatiable demand for products and training aids to help learn a proper golf swing. All previous instruction methods involve an instructor guiding a student through the proper motion. Technical systems such as swing monitors and ball-flight monitors do not guide the student but simply measure results. It is difficult and for many, impossible to duplicate the instructions of a teacher and adopt their directions into one's own swing. This is how bad habits are formed which are often difficult to reverse. It is equally difficult to verbalize instructions in to a practice regimen.

The robotic trainer 100 teaches several basic swing shots:
1. Full swing
   a. Draw
   b. Straight
   c. Cut
2. Knock down
   a. Draw
   b. Straight
   c. Cut
3. Pitch
   a. Draw
   b. Straight
   c. Cut
4. Chip
   a. Draw
   b. Straight
   c. Cut
5. Sand/Bunker
6. Putting

The robot 100 can execute all shots in several speeds:
1. Full speed
2. ¾ speed
3. ½ speed
4. Slow motion

The robot 100 is controlled by voice-activation software. Commands include all combinations of shot type and speed with some natural language derivatives, such as:
1. Full Swing Draw full speed
2. Knock down cut ½ speed
3. Chip shot straight slow motion

Components of the swing:
1. Setup-Address
   a. Correct body position
   b. Correct grip and grip pressure
   c. Head down
   d. Eyes on ball
2. The Takeaway-Backswing (right handed. Reverse for left handed swing)
   a. Arms fully extended
   b. Torso, shoulders and arms rotate
   c. Head down with no movement
   d. Eyes on ball
   e. Hands flat at top of swing
   f. Left shoulder touches chin
   g. Pressure right foot
   h. Pressure left hand to flat position and ready to start rotating over
3. Release-Swing
   a. Head down, eyes on ball throughout swing
   b. Arms fully extended throughout swing
   c. Pressure right foot
   d. Left hip returns to address position
   e. Knees bent throughout swing
   f. Arms start to follow through swing
   g. Left hand starts to rotate under
   h. Right hand starts to rotate over
   i. Accelerate through ball at impact
   j. Hands slightly ahead of club head
   k. Downward striking motion at impact
   l. Right shoulder down to look under
   m. Spine angle maintained
4. Follow Through
   a. Arms fully extended
   b. Right shoulder touches chin
   c. Right hand rotated over left for draw shot
      i. Less rotation for straight shot
      ii. No rotation for cut shot
   d. Torso and hips follow through
      i. Belt buckle points to target
   e. Head comes up to observe shot trajectory
   f. Elbows bend
   g. When elbows fully bent, wrists bend
   h. Left leg becomes fully straight
5. Statue
   a. Hold the pose while observing shot trajectory

The student 200 enters the machine (100), grips a club and addresses the golf ball, speaks the desired shot and says “go” to start the motion. The robot may be augmented with Virtual Reality goggles to “see” the actual shot on a selected course and hole.

Similarly, the robot 100 can have applications to assist patients in rehabilitation from injuries, stroke, chronic illness or other conditions involving muscular atrophy. In the “record” mode, the motion that is to be re-learned or trained is captured by the physical therapist or other medical technician. The patient can then use the device in the “play” mode to employ muscle recruitment and coordination, experience the “target” motion and re-train muscles to approximate the pre-injury or normal condition. By repetition, muscle mass is regenerated and muscle memory is learned or restored.

The robot 100 operates in three modes which the student can observe or join:
1. Automatic Guide Mode
   a. The golf student 200 yields all control by relaxing the muscles and surrenders to the motion of the robot, allowing the machine to guide the student through the swing. The student experiences the correct position of each body part: legs, hips, torso, shoulders, arms, head and hands in the correct sequence of movement.
2. Semi-Automatic Guide Mode
   a. The student 200 engages the muscles and starts a swing which drives the robot, and which causes the robot to offer some resistance and guidance where the swing is out of compliance and directs the student into compliance with the target or perfect swing.
3. Free Swing/Unconstrained Mode
   a. The student 200 is free to make a golf swing uninhibited by the robot. The robotic device measures the components of the student's swing that are out of compliance with the target swing and measures the degree to which the student is out of compliance with visual cues and data. The student can stop at any time to achieve the correct position for any and all components of the swing and observe the light cues as he moves into correct position. (e.g. top of backswing correct position of head, arms, shoulders, hands, hips, torso)
      i. Visual Cues:
         1. Green Light: within 5 degrees of target
         2. Yellow Light: within 20 degrees of target
         3. Red Light: >20 degrees out of compliance
      ii. Data Capture:
         1. Measures and records the degree to which the student has complied with the target or the degree to which the student is out of compliance with the target swing.
         2. The student can analyze the data to see where improvement is needed and the degree to which progress has been made toward the perfect swing.

The embodiments of the invention in which an exclusive property or privilege is claimed are defined as follows:

1. A robotic device comprising at least one from the group of robotic exoskeletons:
for improving a golf swing, and
for assisting patients in rehabilitation.
